(19) United States
(12) Patent Application Publication
(10) Pub. No.: US 2025/0077526 A1
(43) Pub. Date: Mar. 6, 2025

(54) SKEW-CORRECTED DISTRIBUTION OF OBJECTS

(71) Applicant: TERADATA US, INC., San Diego, CA (US)

(72) Inventors: Dhiren Kumar Bhuyan, Telangana (IN); Rameshnadh Pallicheruvu, Telangana (IN); Goutham Ramana Siva Peri, Andhra Pradesh (IN); Sudheer Vaddiboina, Telangana (IN)

(21) Appl. No.: 18/456,749

(22) Filed: Aug. 28, 2023

(51) Int. Cl. G06F 16/2457; G06F 16/2455

(52) U.S. Cl. CPC G06F 16/24573; G06F 16/24542; G06F 16/24556

(57) ABSTRACT

In some examples, a database system receives a database query. The database system computes a threshold based on sizes of objects, and invokes a distribution process that accounts for data skew to distribute the objects of the object store to processing engines. The distribution process includes determining whether an assignment of a first object to a given processing engine causes a load of the given processing engine to exceed the threshold. In response to a determination that the load of the given processing engine exceeds the threshold, the distribution process divides the first object into object parts and distribute the object parts among one or more processing engines. In response to a determination that the load of the given processing engine does not exceed the threshold, the distribution process assigns the first object to the given processing engine.

### BACKGROUND

A relational database management system (DBMS) stores databases that include collections of logically related data arranged in a predetermined format, such as in tables that contain rows and columns. To access the content of a table in a database, queries according to a standard database query language (such as the Structured Query Language or SQL) are submitted to the database. A query can also be issued to insert new entries into a table of a database (such as to insert a row into the table), modify the content of the table, or to delete entries from the table. Examples of SQL statements include INSERT, SELECT, UPDATE, and DELETE.

In other examples, object stores can be used to store objects that are usually larger in size than rows of a table in a relational DBMS. The object stores can be provided in a cloud that is accessible over a network, for example.

### BRIEF DESCRIPTION OF THE DRAWINGS

Some implementations of the present disclosure are described with respect to the following figures.

FIG. 1 is a block diagram of an arrangement including a remote object store and a database management system according to some examples.

FIG. 2 is a flow diagram of a basic skew-corrected distribution process according to some examples.

FIG. 3 is a graph that depicts distributions of data of objects using different distribution processes, in accordance with some examples.

FIG. 4 is a flow diagram of a cost-aware skew-corrected distribution process according to some examples.

FIG. 5 is a block diagram of a database system according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

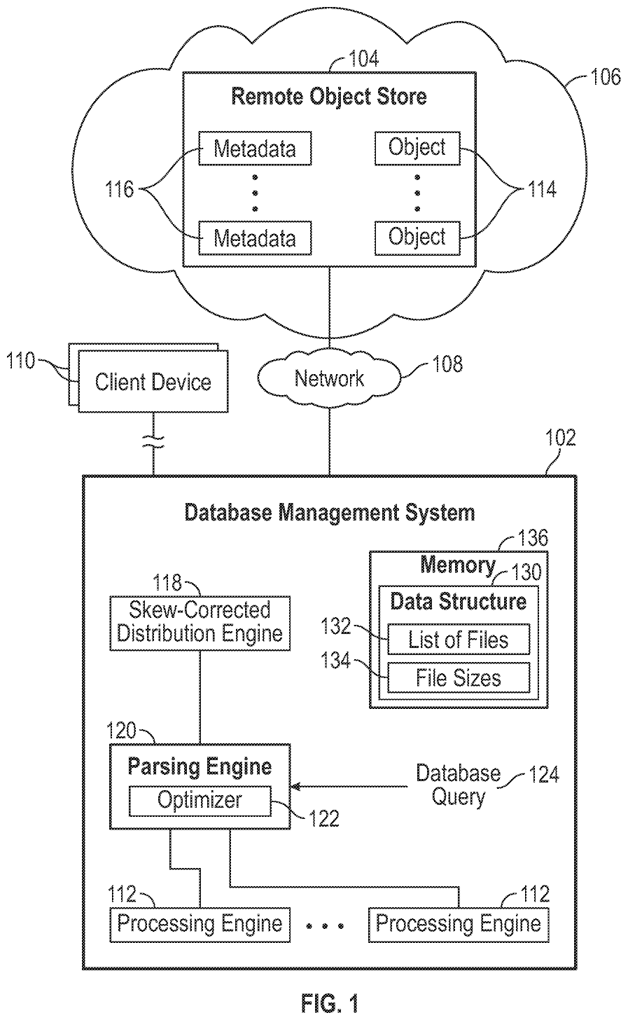

FIG. 1 is a block diagram of an example arrangement that includes a database management system (DBMS) 102 and a remote object store 104. In some examples, the remote object store 104 is an object store that stores objects 114.

The remote object store 104 can be of any of various different types of object stores. For example, the remote object store 104 can be according to any of the following: Simple Storage Service (S3) from AMAZON WEB SERVICES (AWS), Google Cloud Storage, Microsoft AZURE, and so forth. In alternative examples, the object store 104 may be within a data center or part of any other computing environment.

In some examples, the remote object store 104 can be accessible in a cloud 106. A “cloud” can refer to any infrastructure, including computing, storage, and communication resources, that can be accessed remotely by user devices over a network, such as a network 108 shown in FIG. 1. Alternatively, the object store 104 can be provided in a data center or in any other computing environment.

The network 108 can include a public network (e.g., the Internet), a local area network (LAN), a wide area network (WAN), a wireless network (e.g., a wireless local area the network or WLAN, a cellular network, etc.), or any other type of network.

As used here, an “object” can refer to any separately identifiable or addressable unit of data. In some examples, the objects of the remote object store can be in the form of files, such as according to the Apache Parquet format. Apache Parquet specifies an open source, column-oriented data file format to store data associated with database tables. In other examples, the files of the remote object store 104 may be according to the Optimized Row Columnar (ORC) file format. In other examples, the objects 114 of the remote object store 104 can be according to other formats. These objects can be logically divided into sets of rows which can be read independently. These logical sets of rows can be called row groups.

Traditionally, a DBMS stores data of tables in a block-based storage, in which data is stored as blocks that are smaller in size than objects of object stores. A “table” can refer to a relational table of a database created to store specific data records.

In some examples, a block-based storage can include disk-based storage devices, solid state storage devices, and so forth. The block-based storage can be connected to the DBMS over a relatively high-speed link, such that the DBMS can access (read or write) data in a relational database with relatively low input/output (I/O) latency (i.e., the delay between a time that a request is submitted and a time that the request is satisfied at the storage is relatively low). The block-based storage can be considered a local storage of the DBMS, since the DBMS is able to access the block-based storage with relatively low I/O latency.

In some examples of the present disclosure, instead of or in addition to coupling block-based storage (that store relational tables) to the DBMS 102, the DBMS 102 can work with the remote object store 104, which can be provided in the cloud 106 or another remote computing environment. In such examples, local block-based storage is not used with the DBMS 102 to store relational tables.

The objects 114 of the remote object store 104 can have variable sizes (e.g., between tens of megabytes to gigabytes or terabytes). An object in an object store is typically larger in size than data records (e.g., rows, tables, etc.) stored in a local block-based storage.

In the ensuing discussion, reference is made to “files 114” based on an assumption that the remote object store 104 stores files such as according to any of the example file formats noted above. In other examples, techniques or mechanisms according to some implementations of the present disclosure can be applied to other types of objects stored in the remote object store 104.

In some examples, it is assumed that the files 114 in the remote object store 104 are part of unmanaged storage. With unmanaged storage, files are created by programs separate from the DBMS 102, such that the DBMS 102 has no control over characteristics of the files 114, such as the quantity of files, the size of each file, a number of row groups in each file, and so forth.

The DBMS 102 includes multiple processing engines 112 to execute a database operation for a database query received by the DBMS 102. The DBMS 102 includes a parsing engine 120 that is able to receive and process database queries (e.g., SQL queries), including data definition language (DDL) statements and data manipulation language (DML) statements. The parsing engine 120 includes an optimizer 122 that can produce a query plan for a database operation to be executed by the processing engines 112 for processing a given database query.

Database queries can be submitted by one or more client devices 110 to the DBMS 102. The client devices 110 can include any or some combination of the following: a server computer, a desktop computer, a notebook computer, a tablet computer, a smartphone, a game appliance, a vehicle, a household appliance, or any other type of electronic device.

The processing engines 112 are able to execute the database operation in parallel, and the processing engines 112 are able to access, in parallel, different data portions (e.g., different files 114 or different portions of the files 114) of the remote object store 104. Each processing engine 112 is considered a Unit of Parallelism (UOP) that is able to execute in parallel (e.g., concurrently or simultaneously) with one or more other UOPs. Each UOP is able to perform a local relational operation, such as a join operation (e.g., to join data from multiple tables), a sort operation, a merge operation, a data aggregation operation (to aggregate multiple pieces of data into an aggregate value, such as a sum, maximum, minimum, average, median, etc.), and/or any other type of database operation.

In some examples, the multiple processing engines 112 include different computer nodes. In other examples, the multiple processing engines 112 include different processors or cores of multi-core processors. More generally, an “engine” can refer to a hardware processing circuit, which can include any or some combination of a microprocessor, a core of a multi-core microprocessor, a microcontroller, a programmable integrated circuit, a programmable gate array, or another hardware processing circuit. Alternatively, an “engine” can refer to a combination of a hardware processing circuit and machine-readable instructions (software and/or firmware) executable on the hardware processing circuit.

In response to a database query that triggers the DBMS 102 to perform a database operation, the DBMS 102 retrieves files 114 from the remote object store 104, and the DBMS 102 distributes the retrieved files 114 across the processing engines 112. The distribution process used by the DBMS 102 can be a load-balancing distribution process that attempts to balance the workload across the processing engines 112. In some examples, the load-balancing distribution process includes a first-fit decreasing bin packing distribution process (referred to as “first-fit distribution process”), in which the processing engines 112 constitute bins (i.e., each processing engine is treated as a bin) to which files are assigned. Once all the files 114 on which the database operation is to be performed are assigned to respective bins, each processing engine 112 starts reading the assigned files from the remote object store 104 that are assigned to the processing engine 112.

An issue with traditional load-balancing distribution processes including the first-fit distribution process is that data skew may occur that can cause a subset of the processing engines 112 to be overloaded as compared to other processing engine(s) 112 in the DBMS 102.

Tables 1 and 2 below illustrate an example of a first-fit distribution process.

TABLE 1

| File Name | File Size | | Row Group |
|---|---|---|---|
| F1 | 2000 | MB | 5 RGs * 400 MB each |
| F2 | 2000 | MB | 5 RGs * 400 MB each |
| F3 | 5 | MB | 5 RGs * 1 MB each |
| F4 | 5 | MB | 5 RGs * 1 MB each |
| F5 | 5 | MB | 5 RGs * 1 MB each |
| F6 | 5 | MB | 5 RGs * 1 MB each |
| F7 | 5 | MB | 5 RGs * 1 MB each |

In the example of Table 1, there are seven files F1 to F7. Table 1 has three columns, including a File Name column that identifies the names of files (e.g., F1 to F7 in Table 1), a File Size column that specifies the size of each respective file, and a Row Group column that specifies how many row groups (RGs) are included in each file. Each row group includes multiple rows. The Row Group column also identifies the size of each row group.

The attributes represented by the columns of Table 1 for respective files can be part of metadata associated with the files, such as metadata 116 depicted in FIG. 1. The metadata 116 is stored with the files 114 in the remote object store 104. Note that the metadata 116 can be part of the files 114, or the metadata 116 can be separate from the files 114.

In the example of Table 1, files F1 and F2 are relatively large files each having a size of 2000 megabytes (MB). The other files F3-F7 are relatively small files each having a size of 5 MB.

The first-fit distribution process can perform a distribution of the files as follows, assuming that there are five processing engines (PE 0, PE 1, PE 2, PE 3, and PE 4) as listed in Table 2 below.

TABLE 2

| Processing | | | |
|---|---|---|---|
| Engine | Assignment | Total Load | |
| PE 0 | F1 | 2000 | MB |
| PE 1 | F2 | 2000 | MB |
| PE 2 | F3 + F6 | 10 | MB |
| PE 3 | F4 + F7 | 10 | MB |
| PE 4 | F5 | 5 | MB |

The distribution process assigns file F1 to PE 0 (assuming PE 0 has the minimum load among the multiple processing engines). Note that it may be possible for multiple processing engines to all have the same minimum load, in which case the distribution process can select, from the multiple processing engines with the same minimum load, a processing engine using another criterion, such as a random selection criterion, a criterion that selects the processing engine with the lowest identifier, and so forth.

A “load” of a processing engine can be represented by the amount of data that is to be processed by the processing engine. A larger amount of data to be processed by a processing engine corresponds to a larger load of the processing engine, as compared to another processing engine that processes a smaller amount of data (and thus have a smaller load).

The distribution process then assigns file F2 to PE 1, file F3 to PE 2, file F4 to PE3, and file F5 to PE 4. After the assignment of files F2 to F5 to respective PEs 1 to 4, the distribution process assigns file F6 to PE 2, since PE 2 has a minimum load. Then, file F7 is assigned to the next PE 3 with the minimum load.

As depicted in Table 2, file F1 is assigned to PE 0, file F2 is assigned to PE 1, files F3 and F6 are assigned to PE 2, files F4 and F7 are assigned to PE 3, and file F5 is assigned to PE 4. Table 2 also lists the total load of each processing engine: PE 0 has a total load of 2000 MB (which is the size of file F1), PE 1 has a total load of 2000 MB (which is the size of file F2), PE 2 has a total load of 10 MB (which is the combined size of files F3 and F6), PE 3 has a total load of 10 MB (which is the combined size of files F4 and F7), and PE 4 has a total load of 5 MB (which is the size of file F5).

As is apparent based on the above, there is a large difference in load among processing engines PE 0 to PE 4 due to data skew, with PE 0 and PE 1 having a much greater load than processing engines 2-4 (each of PE 0 and PE 1 processes 2000 MB of data, while each of PE 2 to PE 4 processes a much smaller amount of data). As a result, PE 0 and PE 1 would take a much longer time to complete their portion of the database operation than PE 2 to PE 4, which can lead to a delay in completion of the database operation. In other words, PE 0 and PE 1 would become bottlenecks in performing the database operation.

In addition to greater usage of processing resources of heavily loaded processing engines, data skew can also cause errors in usage of spools, which are temporary tables created to store intermediate results during a database operation. A spool can have a certain size, and if a processing engine is processing a large amount of data, an “out-of-spool” error condition may occur when the spool is filled up and no further data can be added to the spool. This may result in the database operation crashing.

Alternatively, data skew can cause the optimizer 122 of the DBMS 102 to over-estimate the size of a spool to be used, to reduce the likelihood of an out-of-spool error condition. Setting the size of the spool may influence a configuration of a cache used to store the spool. Dedicating too much of the cache for a spool may result in other operations suffering in performance.

The data skew in the assignment of files F1 to F7 to PE 0 to PE 4 is due to the granularity of data distribution being at the level of files (i.e., files are not broken into smaller parts for distribution). As a result, the parallelism that can be achieved using a traditional distribution process is a factor of the quantity of files to be distributed. If file sizes are non-uniform, data skew can occur that causes some processing engines to be overloaded when performing a database operation (e.g., join, sort, merge, etc.) while other processing engines are under-utilized.

Also, distribution processes that achieve parallelism on the granularity of files may not be able to balance workload appropriately where there is a large deviation in the sizes of files.

In accordance with some implementations of the present disclosure, a distribution process that accounts for data skew is applied by the DBMS 102. Such a distribution process is referred to as a “skew-corrected distribution process,” which can be performed by a skew-corrected distribution engine 118 of the DBMS 102.

Although the skew-corrected distribution engine 118 is depicted as being separate from the parsing engine 120, in other examples, the skew-corrected distribution engine 118 can be implemented in the parsing engine 120.

Two versions of the skew-corrected distribution process can be applied by the skew-corrected distribution engine 118. A first version is referred to as a basic skew-corrected distribution process, and a second version is referred to as a cost-aware skew-corrected distribution process that selectively applies the basic skew-corrected distribution process based on a cost-benefit determination.

Generally, each version of the skew-corrected distribution process is an online process, which is applied as part of processing of a database query specifying a database operation. Note that the files 114 to be operated on by a database operation in response to the database query and the sizes of the files 114 are not known beforehand (before the database query is received), so that the DBMS 102 has to perform the distribution process after the database query has been received so that the DBMS 102 (and more specifically the skew-corrected distribution engine 118) is able to determine which files 114 are involved in the database operation, and the sizes of such files 114.

### Basic Skew-Corrected Distribution Process

The basic skew-corrected distribution process is able to divide files into smaller file parts for distribution in response to a determination that data skew may occur if the data distribution occurs at the granularity of files. In some examples, a file can be divided into row groups, and the row groups can then be distributed to different processing engines. In other examples, a file (or more generally, any type of object) can be divided into smaller file parts (or more generally smaller object parts) for distribution across processing engines.

The basic skew-corrected distribution process is able to avoid or reduce data skew by performing data distribution at a granularity of data parts that are smaller than files. The basic skew-corrected distribution process does not consider the cost of skew-corrected data distribution. Reducing data skew allows the load of executing a database operation to be more evenly distributed across processing engines. As a result, the performance of the database operation (e.g., a join operation, a sort operation, a merge operation, an aggregation operation, etc.) can be improved due to more even distribution of the data. Additionally, by reducing data skew, out-of-spool error conditions can be avoided or made less likely, and the optimizer 122 is less likely to over-estimate the size of spools to improve usage of a cache and thus improve performance of input/output (I/O) operations.

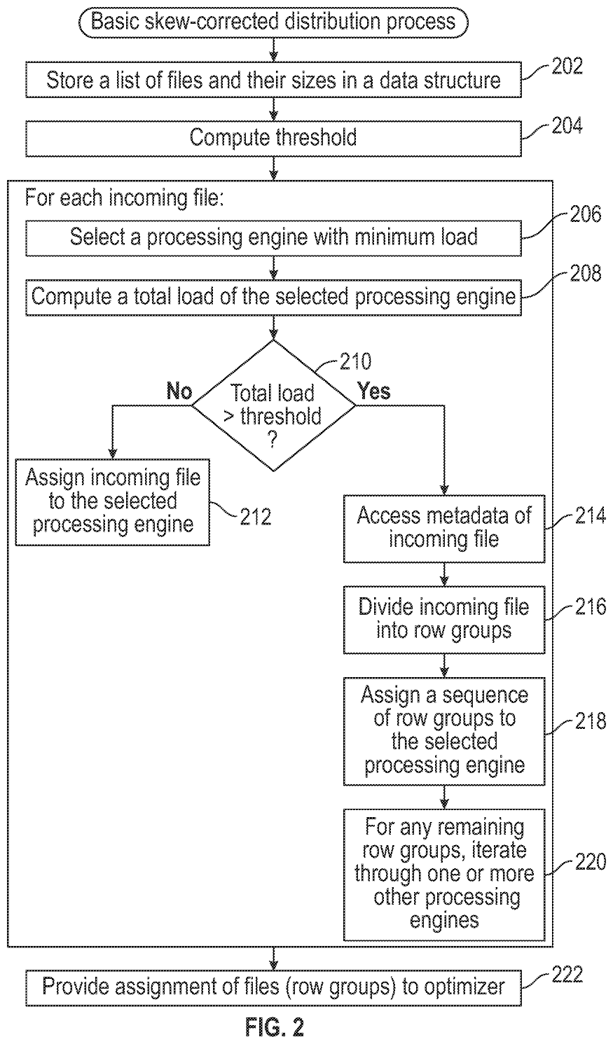

FIG. 2 is a flow diagram of the basic skew-corrected distribution process according to some examples, which can be performed by the skew-corrected distribution engine 118. The following refers to both FIG. 1 and FIG. 2.

In response to a database query 124 received by the parsing engine 120, the optimizer 122 develops a query plan for a database operation to be performed in response to the database query 124. The query plan identifies which files 114 are involved in the database operation. These files are referred to as “identified files.”

The skew-corrected distribution engine 118 stores (at 202) a list of files (or more specifically, a list of file identifiers) and their respective sizes in a data structure 130 stored in a memory 136. The data structure 130 may be in the form of a spool and is retrieved from the remote object store 104 for example and/or derived from the metadata 116 of the files. The list of files (132) in the data structure 130 lists all of the files 114 of the remote object store 104. The data structure 130 also contains the sizes of the files (134). The memory 136 is implemented using one or more memory devices, such as dynamic random access memory (DRAM) devices, static random access memory (SRAM) devices, flash memory devices, and so forth. If retrieved from the remote object store 104, the data structure 130 has to be read just once from the remote object store 104.

The skew-corrected distribution engine 118 computes (at 204) a threshold based on sizes of the identified files 114 (as determined from the data structure 130). In some examples, the threshold is referred to as an AvgFileSizePerPE threshold, which is computed by dividing the total size (TotalFileSize) of the identified files 114 by the total quantity of processing engines (Q_PE):

$$AvgFileSizePerPE = TotalFileSize / ( Q\_PE ) .$$

In an example in which the identified files 114 include files F1 to F7 and the database operation applied on the files F1 to F7 is performed by processing engines PE 0 to PE 4, the AvgFileSizePerPE threshold is computed by dividing the total size of files F1 to F7 by 5 (which is the total quantity of processing engines in this example). The AvgFileSizePerPE threshold represents a target load of each processing engine that would result in an equal distribution of the workload across the processing engines.

More generally, the threshold is computed based on an aggregate (e.g., sum) of the sizes of objects involved in a database operation and a quantity of processing engines.

The skew-corrected distribution engine 118 then processes information of each incoming file of the identified files 114 one at a time. An “incoming file” is a file on which the database operation is to be applied. The information of the incoming file is obtained from the data structure 130 in the memory 136.

In response to the information of the incoming file, the skew-corrected distribution engine 118 selects (at 206), from among the processing engines 112, a processing engine with a minimum load. Note that it is possible that multiple processing engines share the same minimum load. In this case, a tie-breaking criterion can be used by the skew-corrected distribution engine 118 to select from among the multiple processing engines that share the same minimum load. The tie-breaking criterion can be a random selection criterion, a criterion that selects a processing engine with a lower identifier, and so forth.

The skew-corrected distribution engine 118 computes (at 208) a total load that would be experienced by the selected processing engine if the incoming file were to be distributed to the selected processing engine. Note that in some examples a load of the selected processing engine is equal to the size of the data to be processed by the selected processing engine. The total load is based on summing the size of any one or more files (or file parts) that were previously assigned to the selected processing engine and the size of the incoming file.

The skew-corrected distribution engine 118 determines (at 210) if the total load exceeds the AvgFileSizePerPE threshold. A load “exceeds” a threshold if the load is greater than, or alternatively is greater than or equal to, the threshold. If the total load does not exceed the AvgFileSizePerPE threshold, the skew-corrected distribution engine 118 assigns (at 212) the incoming file in its entirety to the selected processing engine.

On the other hand, if the total load exceeds the AvgFileSizePerPE threshold, the skew-corrected distribution engine 118 accesses (at 214) metadata 116 for the incoming file. As noted above, the metadata 116 is stored in the remote object store 104. The metadata 116 is retrieved over the network 108 from the remote object store 104. The accessed metadata 116 includes information of the row groups of the incoming file, such as how many row groups are in the incoming file and the size of each row group.

Based on the accessed metadata 116 of the incoming file, the skew-corrected distribution engine 118 divides (at 216) the incoming file into the row groups of the incoming file. The skew-corrected distribution engine 118 then assigns (at 218) a sequence of the row groups to the selected processing engine. The skew-corrected distribution engine 118 continues to assign row groups of the incoming file to the selected processing engine until assigning a further row group would exceed the AvgFileSizePerPE threshold. Assigning a sequence of multiple row groups to a given processing engine where possible allows for locality of reference, to increase the likelihood that requests for data of a file can be satisfied from the given processing engine rather than having to retrieve the data from multiple processing engines, which may consume more resources.

For example, the incoming file may be divided into row groups RG1, RG2, RG3, RG4, RG5, and RG6. The skew-corrected distribution engine 118 would assign as many of the row groups RG1, RG2, RG3, RG4, RG5, and RG6 as possible to the selected processing engine without exceeding the AvgFileSizePerPE threshold. In an example, RG1 and RG2 may be assigned to the selected processing engine without the total load of the selected processing engine exceeding the AvgFileSizePerPE threshold. If further assigning RG3 to the selected processing engine would exceed the AvgFileSizePerPE threshold, then the skew-corrected distribution engine 118 would not assign RG3 (as well as the remaining row groups RG4, RG5, and RG6) to the selected processing engine. The row groups RG1 and RG2 make up the sequence of row groups of the incoming file assigned to the selected processing engine.

For any remaining row groups of the incoming file, the skew-corrected distribution engine 118 iterates (at 220) through one or more other processing engines successively until all of the remaining row groups of the incoming have been assigned to the one or more other processing engines, subject to the constraint that row groups are assigned to a currently selected processing engine until the AvgFileSizePerPE threshold is reached (i.e., if assigning a row group to the currently selected processing engine would cause the total load of the currently selected processing engine to exceed the AvgFileSizePerPE threshold, then another processing engine would be selected for assignment of any remaining row groups).

The skew-corrected distribution engine 118 assigns the remaining row group(s) to one or more other processing engines, based on further selecting a processing engine with a minimum load and assigning as many of the remaining row group(s) to the further selected processing engine as possible without exceeding the AvgFileSizePerPE threshold. The assignment of the remaining row group(s) is performed by iteratively selecting the next processing engine(s) with the minimum load(s) until all of the remaining row group(s) have been assigned.

For example, if RG3, RG4, RG5, and RG6 are the remaining row groups to be assigned, the skew-corrected distribution engine 118 selects the next processing engine (“processing engine X”), and assigns as many of RG3, RG4, RG5, and RG6 as possible to processing engine X without exceeding the AvgFileSizePerPE threshold. It is assumed that RG3 and RG4 are assigned to processing engine X. The skew-corrected distribution engine 118 then selects another processing engine (“processing engine X+1”), and assigns as many of RG5 and RG6 as possible to processing engine X+1 without exceeding the AvgFileSizePerPE threshold. If any row group remains after the assignment to processing engine X+1, the skew-corrected distribution engine 118 can continue to select another processing engine until the distribution of remaining row groups of the incoming file is complete.

The skew-corrected distribution engine 118 then processes information of the next incoming file until all incoming files on which the database operation is to be applied have been processed. Note that the skew-corrected distribution process is adaptive in nature. Depending on the number of files, sizes of files and number of processing engines, the skew-corrected distribution process adaptively distribute the files by splitting (or not) files on an as-needed basis.

The assignment of files (or row groups of files) to processing engines is then provided (at 222) by the skew-corrected distribution engine 118 to the optimizer 122 for use in developing a query plan that uses the assignment created by the skew-corrected distribution engine 118.

Tables 3 to 5 below depict an example of applying the basic skew-corrected distribution process.

TABLE 3

| Parameter | Value | |
|---|---|---|
| TotalFileSize | 4025 | MB |
| Q_PE | 5 | |
| AvgFileSizePerPE | 805 | MB |

The AvgFileSizePerPE threshold is computed by dividing TotalFileSize (4025 MB) (the total size of the files on which a database operation is to be applied responsive to a database query) by the quantity of processing engines (Q_PE=5). The computed value of the AvgFileSizePerPE threshold is 805 MB in this example.

The incoming files (F1 to F7) to be processed are listed in Table 4 below, along with file size information (e.g., obtained from the data structure 130) and row group information (e.g., obtained from the metadata 116 of each file). Note that Table 4 is copied from Table 1 above.

TABLE 4

| File Name | File Size | | Row Group |
|---|---|---|---|
| F1 | 2000 | MB | 5 RGs * 400 MB each |
| F2 | 2000 | MB | 5 RGs * 400 MB each |
| F3 | 5 | MB | 5 RGs * 1 MB each |
| F4 | 5 | MB | 5 RGs * 1 MB each |
| F5 | 5 | MB | 5 RGs * 1 MB each |
| F6 | 5 | MB | 5 RGs * 1 MB each |
| F7 | 5 | MB | 5 RGs * 1 MB each |

File F1 has size 2000 MB. The skew-corrected distribution engine 118 identifies the processing engine (bin) with minimum load as PE 0 (which currently has no load). Adding the whole file F1 to PE 0 will exceed the threshold of 805 MB. As a result, the skew-corrected distribution engine 118 divides file F1 into row groups (five row groups F1RG1 to F1RG5). The skew-corrected distribution engine 118 sequentially assigns row groups F1RG1, F1RG2 to PE 0. Adding F1RG3 to PE 0 will exceed the threshold so the skew-corrected distribution engine 118 stops at F1RG2. The next two row groups F1RG3 and F1RG4 are assigned to the next processing engine (PE 1) with minimum load. The last row group F1RG5 is assigned to a subsequent processing engine (PE 2) with minimum load.

File F2 has size 2000 MB. The processing engine with minimum load at this point is PE 3, which has no load. Adding the whole file F2 to PE 3 will exceed the threshold of 805 MB. As a result, the skew-corrected distribution engine 118 divides file F2 into row groups (five row groups F2RG1 to F2RG5). The skew-corrected distribution engine 118 assigns F2RG1 and F2RG2 to PE 3. The next two row groups F2RG3 and F2RG4 are assigned to PE 4. The last row group F2RG5 of file 2 is assigned to the processing engine with minimum load, which at this point is PE 2 (with a load of 400 MB at this point).

Files F3 to F7 are assigned to the least loaded processing engines without splitting them as adding these files as a whole does not cross the threshold of 805 mb. After all files are assigned, Table 5 below shows that the load is even across all processing engines.

TABLE 5

| Processing | | | |
|---|---|---|---|
| Engine | Assignment | Load Detail | Total Load |
| PE 0 | F1RG1 + F1RG2 + F3 | 400 + 400 + 5 | 805 MB |
| PE 1 | F1RG3 + F1RG4 + F4 | 400 + 400 + 5 | 805 MB |
| PE 2 | F1RG5 + F2RG5 + F5 | 400 + 400 + 5 | 805 MB |
| PE 3 | F2RG1 + F2RG2 + F6 | 400 + 400 + 5 | 805 MB |
| PE 4 | F2RG3 + F2RG4 + F7 | 400 + 400 + 5 | 805 MB |

In Table 5, the Load Detail column lists the loads attributable to respective files (file groups) assigned to a corresponding PE, where the loads sum to the corresponding total load in the Total Load column.

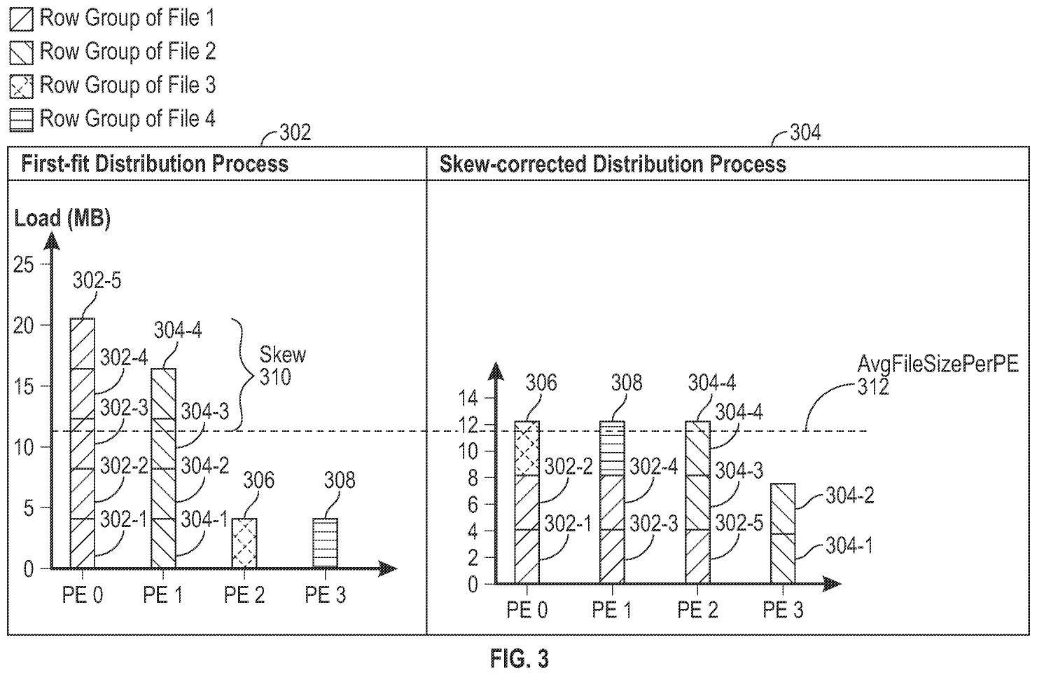

FIG. 3 is a graph that depicts the difference between a first-fit distribution process 302 and a skew-corrected distribution process 304 according to some examples of the present disclosure. The example of FIG. 3 assumes that there are four files (file 1 to file 4) to be distributed across four processing engines (PE 0 to PE 3). In the example of FIG. 3, file 1 has five row groups 302-1 to 302-5, file 2 has four row groups 304-1 to 304-4, file 3 has one row group 306, and file 4 has one row group 308. With the first-fit distribution process 302, file 1 is assigned to PE 0, file 2 is assigned to PE 1, file 3 is assigned to PE 2, and file 4 is assigned to PE 3. As a result of the first-fit distribution process 302, significant skew 310 exists in which both PE 0 and PE 1 has a load that exceeds the AvgFileSizePerPE threshold 312.

In contrast, the skew-corrected distribution process 304 reduces skew in assigning files 1 to 4 to PE 0 to PE 3. In the example of FIG. 3, the assignment of files 1 to 4 according to the skew-corrected distribution process 304 is as follows.

File 1 is divided into its five row groups, and row group 302-1 and row group 302-2 are assigned to PE 0, and row groups 302-3 and 302-4 are assigned to PE 1 (note that assigning row group 302-3 along with 302-1 and 302-2 to PE 0 will cause the total load of PE 0 to exceed AvgFileSizePerPE. Finally, for file 1, row group 302-5 is assigned to PE 2 (note that assigning row group 302-5 to PE 1 along with row groups 302-3 and 302-4 would cause the total load of PE 1 to exceed AvgFileSizePerPE).

File 2 is divided into its five row groups, with workgroups 304-1 and 304-2 assigned to PE 3, and row groups 304-3 and 304-4 assigned to PE 2. The row group 306 of file 3 is assigned to PE 0, and the row group 308 of file 4 is assigned to PE 1.

In the example of FIG. 3, the assignment of row groups 306, 308, and 304-4 to PE 0, PE 1, and PE 2, respectively, causes the total load of each of these PEs to slightly exceed the AvgFileSizePerPE threshold 312. However, note that the skew among PEs 0-3 resulting from the skew-corrected distribution process 304 is much less than the skew among PEs 0-3 resulting from the first-fit distribution process 302.

### Cost-Aware Skew-Corrected Distribution Process

The cost-aware skew-corrected distribution process selectively uses the basic skew-corrected distribution process based on a cost-benefit determination that determines whether the benefit of applying skew reduction when assigning files to processing engines exceeds the cost of applying the skew reduction.

Skew reduction that includes dividing a file into row groups and distributing row groups to processing engines has an overhead cost. The overhead cost is associated with obtaining row group information by retrieving metadata (116) associated with a file from the remote object store 104. Reading the metadata 116 over the network 108 consumes processing and network resources, and the metadata read has a latency. Note that the metadata 116 of files may have to be read multiple times, once to perform the skew-corrected distribution process, and again when files are actually read during a database operation. Reading the metadata 116 multiple times results in increased resource usage.

Additionally, the size of metadata associated with a file may vary from as small as a few kilobytes (KB) to as large as many MB or more. The cost of skew reduction applied by the skew-corrected distribution process may be sometimes expensive compared to the amount of actual data to be read. This may lead to performance degradation for cases (a) when a large number of files are to be read but skew reduction is small, and/or (b) when there is large skew to correct but the columns selected in the database query or the row selectivity of a predicate of the database query is relatively small.

In the various scenarios above, the costs of fetch the metadata 116 to divide files into row groups may exceed the benefit of skew reduction.

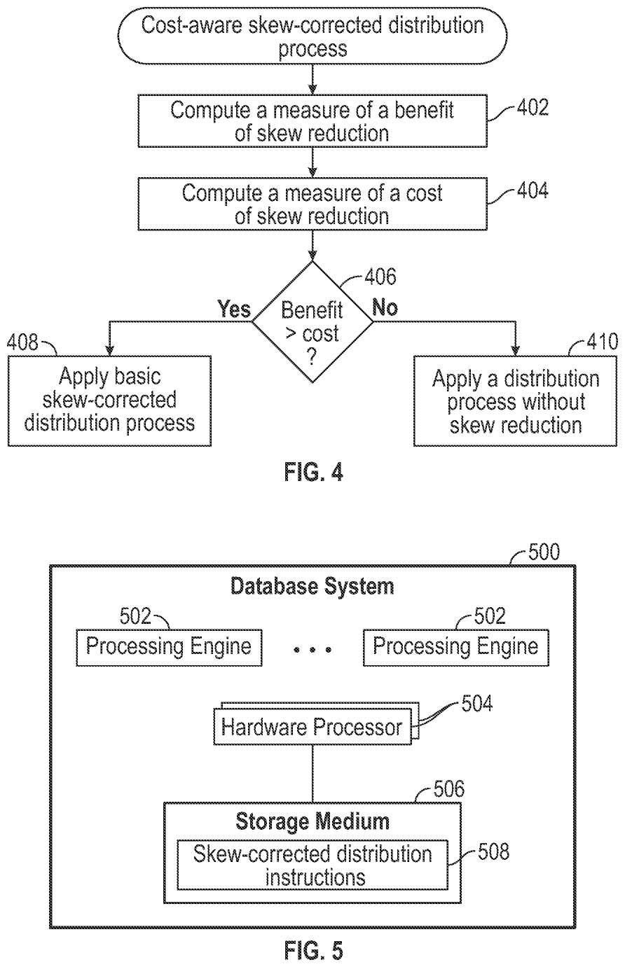

FIG. 4 is a flow diagram of a cost-aware skew-corrected distribution process according to some implementations of the present disclosure. The cost-aware skew-corrected distribution process can be performed by the skew-corrected distribution engine 118 of FIG. 1, for example.

In response to a database query that is to trigger a database operation, the skew-corrected distribution engine 118 computes (at 402) a measure of a benefit (Benefit) if skew reduction is applied based on use of the basic skew-corrected distribution process. The skew-corrected distribution engine 118 computes (at 404) a measure of a cost (Cost) of the basic skew-corrected distribution process. The skew-corrected distribution engine 118 determines (at 406) whether the benefit exceeds the cost based on the computed measure of the benefit and the computed measure of the cost. More specifically, the skew-corrected distribution engine 118 determines whether Benefit—Cost>0.

If the benefit exceeds the cost, the skew-corrected distribution engine 118 applies (at 408) the basic skew-corrected distribution process (according to FIG. 2, for example). However, if the benefit does not exceed the cost, the skew-corrected distribution engine 118 applies (at 410) a distribution process without skew reduction, such as the first-fit distribution process discussed above.

In further examples, the cost-aware skew-corrected distribution process includes Tasks 1 to 5 below.

Task 1: The skew-corrected distribution engine 118 performs an assignment of files to processing engines using a distribution process without skew reduction, such as the first-fit distribution process discussed above. For each file assigned to a processing engine that causes the total load of the processing engine to exceed the AvgFileSizePerPE threshold, the skew-corrected distribution engine 118 adds an identifier of the file (e.g., filename or another identifier) along with a size of the file to a data structure (e.g., referred to as Exceed_Threshold_Files). The data structure (e.g., Exceed_Threshold_Files) would include a list of file identifiers and associated sizes for files that when assigned to respective processing engines cause the total load of each such processing engine to exceed the AvgFileSizePerPE threshold.

Task 2: Due to the assignment of files performed in Task 1, the skew-corrected distribution engine 118 determines which processing engine has the largest load (e.g., the largest amount of data assigned), and records this largest load as PeakLoadedPESize. The skew-corrected distribution engine 118 further records a quantity of files whose assignment to processing engines caused the AvgFileSizePerPE threshold to be exceeded as nFilesRG.

Task 3: The skew-corrected distribution engine 118 computes the measure of benefit (Benefit) according to the following equation, for example:

$$Benefit = ( PeakLoadedPESize - AvgFileSizePerPE ) * Column\_Factor * Selectivity * X\_Factor .$$

The parameter Column_Factor is a ratio based on dividing a total size of columns selected in a Select clause of a database query to a total size of columns present in relational tables involved in a database operation specified by the database query. The files 114 of the remote object store 104 are part of the relational tables involved in the database operation. The relational tables involved in the database operation collectively have a total quantity of unique columns (T). The quantity of columns selected by the database query is (S). In this example, Column_Factor=(Sum of size of all the columns in S)/(Sum of size of all the columns in T).

The parameter Selectivity is a ratio that represents selectivity of rows of tables as specified in a predicate of a database query. Note that values of the parameters Column_Factor and Selectivity can be provided by the optimizer 122.

The parameter X_Factor is a scaling factor that is empirically determined, such as by a human, a program, or a machine. In other examples, X_Factor may be omitted.

Task 4: The skew-corrected distribution engine 118 computes the measure of cost (Cost) according to the following equation, for example:

$$Cost = ( 2 * nFilesRG ) * AvgFileMetsadataSize .$$

The parameter nFilesRG is obtained from Task 2. The parameter AvgFileMetadataSize represents an average size of the metadata 116 associated with files involved in the database operation. The parameter AvgFileMetadataSize may be preconfigured or may be computed by the skew-corrected distribution engine 118 or by another module.

Task 5: The skew-corrected distribution engine 118 determines if Benefit—Cost>0. If so, the skew-corrected distribution engine 118 retrieves each file identified in Exceed_Threshold_Files (as created in Task 1) and divides each such file into row groups. The row groups of such files are assigned to processing engines.

### Further Examples

FIG. 5 is a block diagram of a database system 500. An example of the database system 500 is the DBMS 102 of FIG. 1. The database system 500 includes a plurality of processing engines 502, one or more hardware processors 504, and a non-transitory machine-readable or computer-readable storage medium 506 storing machine-readable instructions.

A hardware processor can include a microprocessor, a core of a multi-core microprocessor, a microcontroller, a programmable integrated circuit, a programmable gate array, or another hardware processing circuit.

The machine-readable instructions include skew-corrected distribution instructions 508 that can perform tasks of the skew-corrected distribution engine 118, for example. The skew-corrected distribution instructions 508 access metadata of objects (e.g., files 114) stored in a remote store (e.g., 104) coupled to the database system 500 over a network. The skew-corrected distribution instructions 508 compute a threshold based on sizes of the objects. An example of the threshold is the AvgFileSizePerPE threshold discussed above.

The skew-corrected distribution instructions 508 invoke a distribution process that accounts for data skew to distribute the objects of the remote store to the plurality of processing engines 502. The distribution process includes determining whether an assignment of a first object to a given processing engine causes a load of the given processing engine based on a size of the first object to exceed the threshold. The load of the given processing engine would exceed the threshold if the size of the first object in combination with the size of any previously assigned object(s) to the given processing engine exceeds the threshold, for example. In some examples, the skew-corrected distribution instructions 508 identify a least loaded processing engine of the plurality of processing engines as the given processing engine.

In response to a determination that the load of the given processing engine exceeds the threshold, the distribution process divides the first object into object parts and distributes the object parts among one or more processing engines of the plurality of processing engines 502.

In response to a determination that the load of the given processing engine does not exceed the threshold, the distribution process assigns the first object in its entirety to the given processing engine of the plurality of processing engine.

In some examples, the computing of the threshold based on the sizes of the objects includes calculating the threshold based on an aggregate of the sizes of the objects and a quantity of the plurality of processing engines 502, such as by dividing a total size of the objects by a quantity of the plurality of processing engines 502.

In some examples, as part of the distributing of the object parts among the one or more processing engines, the distribution process assigns a first object part of the object parts to the given processing engine, and determines whether assigning a second object part of the object parts to the given processing engine would cause the threshold to be exceeded (i.e., cause a total load of the given processing engine to exceed the threshold). In response to determining that assigning the second object part to the given processing engine would not cause the threshold to be exceeded, the distribution process assigns the second object part to the given processing engine.

In response to determining that assigning the second object part to the given processing engine would cause the threshold to be exceeded, the distribution process assigns the second object part to a second processing engine of the plurality of processing engines 502.

A storage medium (e.g. 504) can include any or some combination of the following: a semiconductor memory device such as a DRAM or SRAM, an erasable and programmable read-only memory (EPROM), an electrically erasable and programmable read-only memory (EEPROM) and flash memory or other type of non-volatile memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine readable storage medium comprising instructions that upon execution cause a database system comprising a plurality of processing engines to:
access metadata of objects stored in a remote store coupled to the database system over a network;
compute a threshold based on sizes of the objects; and
invoke a distribution process that accounts for data skew to distribute the objects of the remote store to the plurality of processing engines, the distribution process comprising:
determining whether an assignment of a first object to a given processing engine causes a load of the given processing engine based on a size of the first object to exceed the threshold,
in response to a determination that the load of the given processing engine exceeds the threshold, dividing the first object into object parts and distribute the object parts among one or more processing engines of the plurality of processing engines, and
in response to a determination that the load of the given processing engine does not exceed the threshold, assigning the first object to the given processing engine of the plurality of processing engine.

2. The non-transitory machine readable storage medium of claim 1, wherein the computing of the threshold based on the sizes of the objects comprises calculating the threshold based on an aggregate of the sizes of the objects and a quantity of the plurality of processing engines.

3. The non-transitory machine readable storage medium of claim 1, wherein the computing of the threshold based on the sizes of the objects comprises calculating the threshold by dividing a total size of the objects by a quantity of the plurality of processing engines.

4. The non-transitory machine readable storage medium of claim 1, wherein the distribution process is an online distribution process performed during processing of a database query specifying a database operation applied to data of the objects.

5. The non-transitory machine readable storage medium of claim 1, wherein the instructions upon execution cause the database system to:
identify a least loaded processing engine of the plurality of processing engines as the given processing engine.

6. The non-transitory machine readable storage medium of claim 1, wherein the instructions upon execution cause the database system to:
as part of the distributing of the object parts among the one or more processing engines:
assign a first object part of the object parts to the given processing engine,
determine whether assigning a second object part of the object parts to the given processing engine would cause the threshold to be exceeded, and
in response to determining that assigning the second object part to the given processing engine would not cause the threshold to be exceeded, assign the second object part to the given processing engine.

7. The non-transitory machine readable storage medium of claim 6, wherein the instructions upon execution cause the database system to:
in response to determining that assigning the second object part to the given processing engine would cause the threshold to be exceeded, assign the second object part to a second processing engine of the plurality of processing engines.

8. The non-transitory machine readable storage medium of claim 6, wherein the assigning of the first object part to the given processing engine comprises identifying a least loaded processing engine of the plurality of processing engines as the given processing engine.

9. The non-transitory machine readable storage medium of claim 1, wherein the objects stored in the remote store comprise files.

10. The non-transitory machine readable storage medium of claim 1, wherein the dividing of the first object into the object parts comprises dividing the first object into a plurality of row groups, wherein each row group of the plurality of row groups comprises multiple rows of data.

11. The non-transitory machine readable storage medium of claim 1, wherein the instructions upon execution cause the database system to:
determine whether a benefit associated with performing the distribution process that accounts for data skew exceeds a cost associated with performing the distribution process that accounts for data skew,
wherein the invoking of the distribution process that accounts for data skew is performed in response to determining that the benefit associated with performing the distribution process that accounts for data skew exceeds the cost associated with performing the distribution process that accounts for data skew.

12. The non-transitory machine readable storage medium of claim 11, wherein the instructions upon execution cause the database system to:
compute a measure of the benefit associated with performing the distribution process that accounts for data skew based on a largest load of a processing engine if a second distribution process different from the distribution process that accounts for data skew is employed.

13. The non-transitory machine readable storage medium of claim 12, wherein the computing of the measure of the benefit is further based on an average-per-processing-engine size derived from dividing a total size of the objects by a quantity of the plurality of processing engines.

14. The non-transitory machine readable storage medium of claim 13, wherein the computing of the measure of the benefit is further based on a quantity of table columns selected in a select clause of a database query and based on a selectivity of a predicate of the database query.

15. The non-transitory machine readable storage medium of claim 11, wherein the instructions upon execution cause the database system to:
compute a measure of the cost associated with performing the distribution process that accounts for data skew based on a quantity of the objects whose assignment to processing engines caused the threshold to be exceeded and an average size of the metadata of the objects.

16. The non-transitory machine readable storage medium of claim 1, wherein the instructions upon execution cause the database system to:
for a second set of objects, in response to determining that a benefit associated with performing a distribution process that accounts for data skew of the second set of objects does not exceed a cost associated with performing the distribution process that accounts for data skew of the second set of objects, invoke a second distribution process to distribute the second set of objects without dividing any object of the second set of objects into smaller object parts.

17. A database system comprising:
a plurality of processing engines;
a processor; and
a non-transitory machine-readable storage medium storing instructions executable on the processor to:
receive a database query;
compute a first measure of a benefit of applying a distribution process that performs skew reduction;
compute a second measure of a cost of applying the distribution process that performs skew reduction;
determine whether the benefit exceeds the cost based on the first measure and the second measure; and
in response to determining that the benefit exceeds the cost, apply the distribution process that performs skew reduction to distribute objects across the plurality of processing engines, wherein the distribution of the objects comprises dividing at least one object of the objects into object parts that are distributed across processing engines.

18. The database system of claim 17, wherein the instructions are executable on the processor to:
in response to determining that the benefit does not exceed the cost, apply a different distribution process that does not perform skew reduction.

19. The database system of claim 17, wherein the distribution of the objects comprises:
computing a threshold based on sizes of the objects,
determining whether an assignment of a first object to a given processing engine causes a load of the given processing engine based on a size of the first object to exceed the threshold,
in response to a determination that the load of the given processing engine exceeds the threshold, dividing the first object into object parts and distribute the object parts of the first object among one or more processing engines of the plurality of processing engines, and
in response to a determination that the load of the given processing engine does not exceed the threshold, assigning the first object to the given processing engine of the plurality of processing engines.

20. A method of a database system comprising a hardware processor, the method comprising:
receiving a database query that operates on objects of an object store remote from the database system;
computing a threshold based on sizes of the objects; and
invoking a distribution process that accounts for data skew to distribute the objects of the object store to the plurality of processing engines, the distribution process comprising:
determining whether an assignment of a first object to a given processing engine causes a load of the given processing engine based on a size of the first object to exceed the threshold,
in response to a determination that the load of the given processing engine exceeds the threshold, dividing the first object into object parts and distribute the object parts among one or more processing engines of the plurality of processing engines, and
in response to a determination that the load of the given processing engine does not exceed the threshold, assigning the first object to the given processing engine.
